(19) United States
(12) Patent Application Publication
(10) Pub. No.: US 2026/0118811 A1
(43) Pub. Date: Apr. 30, 2026

(54) SHEET CONTAINING DEVICE AND IMAGE FORMING APPARATUS

(71) Applicant: Sharp Kabushiki Kaisha, Sakai City (JP)

(72) Inventor: Ryo KAWABATA, Sakai City (JP)

(21) Appl. No.: 19/365,267

(22) Filed: Oct. 22, 2025

(30) Foreign Application Priority Data
Oct. 29, 2024 (JP) 2024-189794

(51) Int. Cl. G03G 15/00

(52) U.S. Cl. CPC G03G 15/6511; G03G 15/6558; G03G 2215/00383; G03G 2215/00396; G03G 2215/004

(57) ABSTRACT

A sheet containing device is configured such that a driving-side reversal parallel axis gear can be separated from a driven-side reversal parallel axis gear, and imaginary tangent lines ω1 and ω2 of contact surfaces of a driving-side gear tooth meshing portion and a driven-side gear tooth meshing portion at a position in which the driving-side reversal parallel axis gear and the driven-side reversal parallel axis gear are meshed with each other always intersect with a first imaginary straight line γ1 passing through a first rotation axis α1 of the driving-side reversal parallel axis gear and a second rotation axis α2 of the driven-side reversal parallel axis gear through rotation of the driving-side reversal parallel axis gear.

### FIELD OF THE INVENTION

The present disclosure relates to a sheet containing device included in an image forming apparatus such as a copy machine, a multifunctional device, a printer, and a facsimile device, and an image forming apparatus.

### BACKGROUND ART

The sheet containing device generally includes a sheet containing case (feed cassette), and the sheet containing case is provided so as to be insertable into and removable from a sheet containing device main body.

Such a sheet containing case includes a sheet placement section on which sheets are placed, and a case side driving force transmission mechanism that transmits driving force for lifting up the sheet placement section to the sheet placement section. In this case, the sheet containing device main body includes a driving source and a main body side driving force transmission mechanism that transmits driving force from the driving source to the case side driving force transmission mechanism.

### SUMMARY

### Technical Problem

Incidentally, in the sheet containing device in which the sheet containing case that lifts up the sheet placement section is provided so as to be insertable into and removable from the sheet containing device main body, for example, a driving-side reversal parallel axis gear and a driven-side reversal parallel axis gear may be provided respectively in the main body side driving force transmission mechanism and the container side driving force transmission mechanism. Here, the “reversal parallel axis gears” refers to gears in which external gears of the respective gears mesh with each other and rotate in different directions so that the axes of the two gears meshing with each other become parallel to each other, and a spur gear can be cited as a representative example.

In such a sheet containing device, an upper limit position detection unit that detects an upper limit position (a stop position) of the sheet placement section is provided. When the upper limit position detection unit detects the upper limit position of the sheet placement section, driving of the driving source is stopped.

However, the upper limit position of the sheet placement section is not detected due to a failure or the like of the upper limit position detection unit, and in such a case, the driving of the driving source is not stopped even when the sheet placement section is located at the upper limit position, and lift-up operation of the sheet placement section may be excessively performed. As a result, the driving-side reversal parallel axis gear and/or the driven-side reversal parallel axis gear may be damaged.

In this regard, in the related art, a known sheet containing device includes a gear-side arm that is released when a phase shift is generated between a drive gear and a sector gear. However, this sheet containing device does not solve the problem related to damage to the driving-side reversal parallel axis gear and/or the driven-side reversal parallel axis gear when the upper limit position of the sheet placement section is not detected due to a failure or the like of the upper limit position detection unit.

The disclosure is thus intended to provide a sheet containing device and an image forming apparatus that are capable of effectively prevent damage to a driving-side reversal parallel axis gear and/or a driven-side reversal parallel axis gear when an upper limit position of a sheet placement section is not detected due to a failure or the like of an upper limit position detection unit.

### Solution to Problem

In order to the problem above, a sheet containing device according to the disclosure includes a sheet containing case that includes a sheet placement section on which a sheet is placed and a case side driving force transmission mechanism that transmits driving force for lifting up the sheet placement section to the sheet placement section, the sheet containing case being disposed to be insertable into and removable from a sheet containing device main body comprising a driving source and a main body side driving force transmission mechanism that transmits the driving force from the driving source to the case side driving force transmission mechanism. The main body side driving force transmission mechanism includes a driving-side reversal parallel axis gear to which the driving force is transmitted. The case side driving force transmission mechanism includes a driven-side reversal parallel axis gear that can mesh with the driving-side reversal parallel axis gear when the sheet containing case is inserted into the sheet containing device main body. In a state where the sheet containing case is inserted into the sheet containing device main body, the driving-side reversal parallel axis gear can be separated from the driven-side reversal parallel axis gear. Imaginary tangent lines of contact surfaces of a driving-side gear tooth meshing portion and a driven-side gear tooth meshing portion at a position in which the driving-side reversal parallel axis gear and the driven-side reversal parallel axis gear are meshed with each other always intersect with a first imaginary straight line passing through a first rotation axis of the driving-side reversal parallel axis gear and a second rotation axis of the driven-side reversal parallel axis gear through rotation of the driving-side reversal parallel axis gear.

An image forming device according to the disclosure includes the sheet containing device according to the aforementioned disclosure.

### Advantageous Effects of Disclosure

According to the disclosure, when an upper limit position of the sheet placement section is not detected due to a failure or the like of an upper limit position detection unit, damage to the driving-side reversal parallel axis gear and/or the driven-side reversal parallel axis gear can be effectively prevented.

### BRIEF DESCRIPTION OF THE DRAWINGS

FIG. 1 is a cross-sectional view illustrating an image forming apparatus according to an embodiment of the disclosure.

FIG. 2 is a perspective view of a sheet containing device, illustrating a state in which an example of a sheet containing case is pulled out from a sheet containing device main body, as viewed from obliquely above on the front side.

FIG. 3 is a perspective view of the sheet containing device, illustrating a state in which an example of the sheet containing case is pulled out from the sheet containing device main body, as viewed from obliquely below on the front side.

FIG. 4 is a schematic view of the sheet containing device, schematically illustrating a state in which the sheet containing case is inserted into the sheet containing device main body.

FIG. 5 is a perspective view of a driving-side gear train and a driven-side gear train when the sheet containing case is inserted into the sheet containing device main body, as viewed from above on the front side.

FIG. 6 is a perspective view including a vertical cross-section illustrating a state in which a sheet placement section of the sheet containing device is located at an upper limit position.

FIG. 7 is a schematic view schematically illustrating a state in which the sheet placement section of the sheet containing device is located at a lower limit position.

FIG. 8 is a schematic view schematically illustrating a state in which the sheet placement section of the sheet containing device is located at the upper limit position.

FIG. 9 is a front view illustrating a rotational process of a driving-side gear and a driven-side gear.

FIG. 10 is a front view illustrating the rotational process of the driving-side gear and the driven-side gear.

FIG. 11 is a front view illustrating a meshed state between driving-side gear tooth meshing portions and driven-side gear tooth meshing portions when the sheet placement section reaches the upper limit position.

FIG. 12 is a front view illustrating a state (gear slipped state) in which the driving-side gear tooth meshing portions are disengaged from the driven-side gear tooth meshing portions in a case where driving of a driving source is not stopped even when the sheet placement section is located at the upper limit position.

FIG. 13 is a perspective view of the driving-side gear, an upstream-side gear, and a support member as viewed from the front side.

FIG. 14 is a perspective view of the driving-side gear, the upstream-side gear, the support member, the driven-side gear, and an arc-shaped gear as viewed from the rear side.

FIG. 15 is a perspective view of an example of a restricting portion that restricts swinging of the support member, as viewed from the rear side.

FIG. 16 is a rear view of an example of the restricting portion that restricts swinging of the support member, as viewed from the rear side.

### DESCRIPTION OF EMBODIMENTS

Embodiments according to the disclosure will be described below with reference to the drawings. In the following description, the same components are denoted by the same reference signs. The names and functions of the components are also the same. Accordingly, detailed descriptions thereof are not repeated.

### Image Forming Apparatus

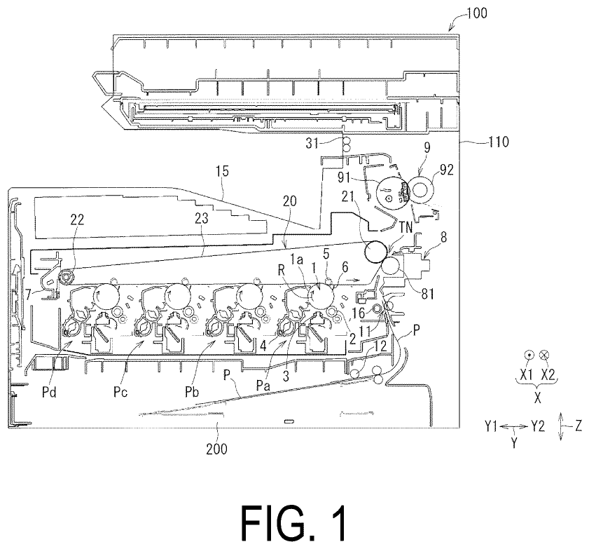

FIG. 1 is a cross-sectional view illustrating an image forming apparatus 100 according to an embodiment of the disclosure. The following description will be given based on designations in the drawings in which the left-right direction is denoted as X, the right side as X1, the left side as X2, the direction orthogonal to the left-right direction X as the depth direction Y, the front side as Y1, the rear side as Y2, and the vertical direction orthogonal to both the left-right direction X and the depth direction Y as Z.

The image data used in the image forming apparatus main body 110 of the image forming apparatus 100 corresponds to a color image composed of the colors black (K), cyan (C), magenta (M), and yellow (Y), or a monochrome image composed of a single color (black, for example). Accordingly, four photoconductor drums 1 (as an example of an image carrier), four chargers 2, four print heads 3, four development devices 4, four primary transfer devices 5, and four drum cleaning devices 6 are provided to form four types of toner images corresponding to respective colors. These are respectively associated with black, cyan, magenta, and yellow, thereby forming four image stations Pa, Pb, Pc, and Pd. Note that the image forming apparatus 100 may be a monochrome image forming apparatus.

At the image stations Pa, Pb, Pc, and Pd, the chargers 2 to 2 uniformly charge, to a predetermined potential, surfaces 1a of the photoconductor drums 1 to 1 rotationally driven in a predetermined rotation direction R. The print heads 3 to 3 expose the surfaces 1a of the photoconductor drums 1 to 1 to form electrostatic latent images on the surfaces 1a of the photoconductor drums 1 to 1. The development devices 4 develop the electrostatic latent images on the surfaces 1a of the photoconductor drums 1 to 1 to form toner images on the surfaces 1a of the photoconductor drums 1 to 1. Thus, the toner images of the respective colors are formed on the surfaces 1a of the photoconductor drums 1 to 1. The drum cleaning devices 6 to 6 remove and collect the remaining toners on the surfaces 1a of the photoconductor drums 1 to 1. The primary transfer devices 5 to 5 sequentially superimpose and transfer the color toner images on the surfaces 1a of the photoconductor drums 1 to 1 to an intermediate transfer belt 23 circulated by a driving roller 21 and a driven roller 22 of a belt drive device 20, thereby forming color toner images on the intermediate transfer belt 23. A belt cleaning device 7 removes and collects the remaining toners on the intermediate transfer belt 23.

A transfer nip portion TN is formed between the intermediate transfer belt 23 and a transfer roller 81 of a secondary transfer device 8. The transfer roller 81 of the secondary transfer device 8 conveys a sheet P such as recording paper or the like that has been conveyed through a sheet conveyance path 11 together with the intermediate transfer belt 23 by sandwiching the sheet P at the transfer nip portion TN, while transferring the color toner images on the surface of the intermediate transfer belt 23 onto the sheet P. A fixing device 9 fixes the color toner image on the sheet P by applying heat and pressure with the sheet P sandwiched between a fixing member (in this example, a fixing belt 91) and a pressing member (in this example, a pressure roller 92).

The sheet P is pulled out from the sheet containing device 200 by a pickup roller 12 and is conveyed through the sheet conveyance path 11. Then, the sheet P passes through the secondary transfer device 8 and the fixing device 9, and is conveyed through discharge rollers 31 to a discharge tray 15. A registration roller 16 and the like are disposed in the sheet conveyance path 11. The registration roller 16 temporarily stops the sheet P and aligns the leading end of the sheet P, and then starts the conveyance of the sheet P in synchronization with the transfer timing for the toner image at the transfer nip portion TN between the intermediate transfer belt 23 and the transfer roller 81. Note that the sheet P is conveyed along the sheet conveyance path 11 with reference to the center of the image forming apparatus main body 110 in the rotation axis direction (left-right direction X) of the photoconductor drums 1 to 1.

### Sheet Containing Device

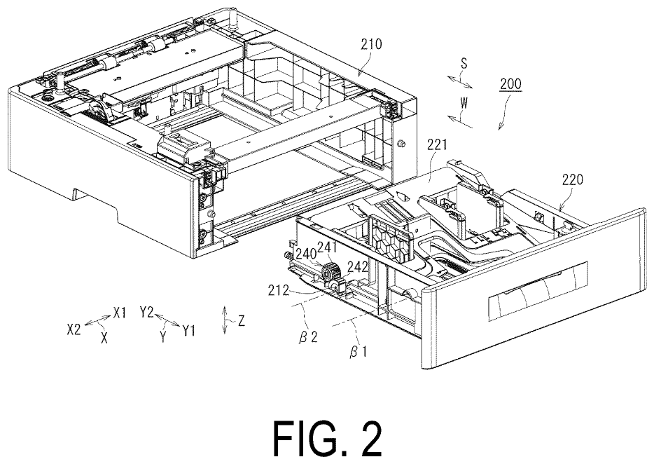

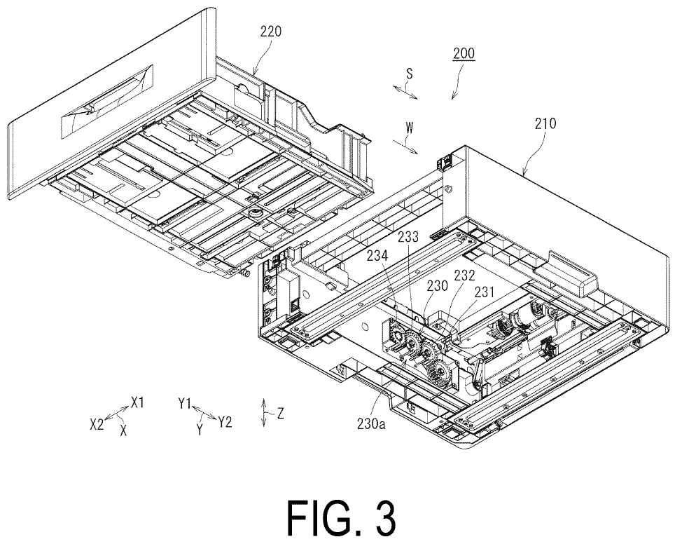

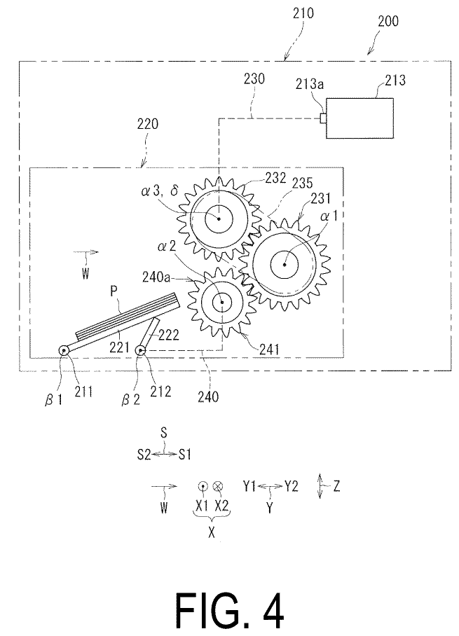

FIGS. 2 and 3 are perspective views of the sheet containing device 200, illustrating a state in which an example of a sheet containing case 220 is pulled out from a sheet containing device main body 210, as viewed from obliquely above and obliquely below on the front side, respectively. In FIG. 3, a cover member covering a main body side driving force transmission mechanism 230 is removed. In addition, FIG. 4 is a schematic view of the sheet containing device 200, schematically illustrating a state in which the sheet containing case 220 is inserted into the sheet containing device main body 210.

As illustrated in FIGS. 2 to 4, the sheet containing device 200 includes the sheet containing case 220 (a feed cassette). The sheet containing case 220 includes a sheet placement section 221 (see FIGS. 2 and 4) (sheet placement plate) and a case side driving force transmission mechanism 240 (see FIGS. 2 and 4). The sheet P is placed on the sheet placement section 221. The case side driving force transmission mechanism 240 transmits driving force for lifting up (raising) the sheet placement section 221 to the sheet placement section 221. Accordingly, the sheet placement section 221 can be lifted up by the driving force transmitted from the case side driving force transmission mechanism 240, and thus the leading end portion (the end portion on the downstream side in a conveyance direction W) of the uppermost sheet P placed on the sheet placement section 221 can be positioned upward. In this example, the sheet placement section 221 pivots about a first pivot axis β1 orthogonal to the conveyance direction W of the sheet P. Here, “rotation” refers to a rotation of 360 degrees or more, and “pivotal movement” refers to a pivotal movement of less than 360 degrees. The sheet containing case 220 further includes a push-up member 222. The push-up member 222 is located below the sheet placement section 221, and pivots about a second pivot axis β2 extending along the first pivot axis β1 to push up the sheet placement section 221. Thus, the case side driving force transmission mechanism 240 can transmit the driving force for lifting up the sheet placement section 221 to the sheet placement section 221 via the push-up member 222.

The sheet containing device main body 210 includes a driving source 213 (see FIG. 4) (a stepping motor) and the main body side driving force transmission mechanism 230 (see FIGS. 3 and 4). The main body side driving force transmission mechanism 230 transmits driving force from the driving source 213 to the case side driving force transmission mechanism 240 in a state where the sheet containing case 220 is inserted in the sheet containing device main body 210.

The sheet containing case 220 is provided so as to be insertable into and removable from the sheet containing device main body 210 in an insertion and removal direction S in the conveyance direction W.

The main body side driving force transmission mechanism 230 includes a driving-side reversal parallel axis gear (hereinafter, simply referred to as a driving-side gear in this section) 231 (refer to FIGS. 3 and 4) to which the driving force is transmitted.

The case side driving force transmission mechanism 240 includes a driven-side reversal parallel axis gear (hereinafter, simply referred to as a driven-side gear in this section) 241 (see FIGS. 2 and 4) that can mesh with the driving-side gear 231 when the sheet containing case 220 is inserted into the sheet containing device main body 210.

Specifically, the driving source 213 is provided in the sheet containing device main body 210, and transmits the driving force from the main body side driving force transmission mechanism 230 and the case side driving force transmission mechanism 240 to the sheet placement section 221 via the push-up member 222.

In other words, the sheet placement section 221 is provided in the sheet containing case 220 so as to be pivotal about the first pivot axis β1 (with a first pivot shaft 211 as a fulcrum) along the left-right direction X (width direction) orthogonal to the conveyance direction W of the sheet P. The sheet containing case 220 contains the sheets P placed on the sheet placement section 221. The push-up member 222 is provided in the sheet containing case 220 so as to be pivotal about the second pivot axis β2 (with a second pivot shaft 212 as a fulcrum) below the leading end side (downstream side of the central portion in the conveyance direction W) of the sheet placement section 221.

Accordingly, the push-up member 222 can push up the lower surface of the distal end side of the sheet placement section 221 by pivoting around the second pivot axis β2 and move the distal end side of the sheet placement section 221 from a lower limit position to an upper limit position.

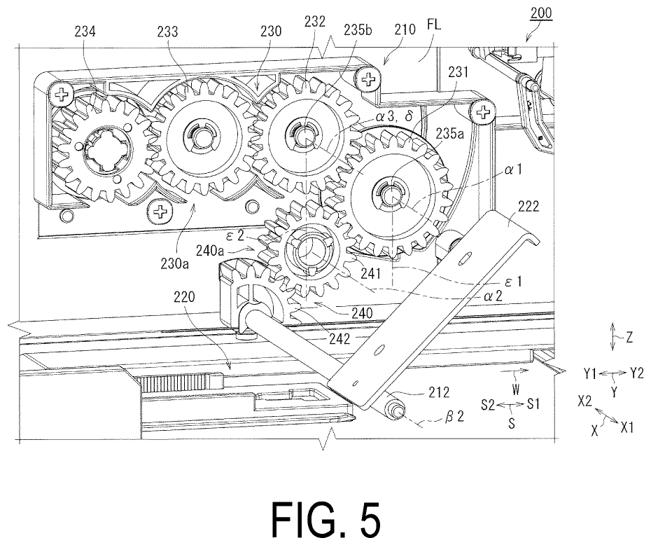

FIG. 5 is a perspective view of a driving-side gear train 230a and a driven-side gear train 240a when the sheet containing case 220 is inserted into the sheet containing device main body 210, as viewed from above on the front side.

The main body side driving force transmission mechanism 230 includes the driving-side gear train 230a including a plurality of main body side gears. In this example, the driving-side gear train 230a includes the driving-side gear 231, an upstream-side reversal parallel axis gear (hereinafter, simply referred to as an upstream-side gear in this section) 232, an intermediate reversal parallel axis gear (hereinafter, simply referred to as an intermediate gear) 233, and a motor reversal parallel axis gear (hereinafter, simply referred to as a motor gear) 234.

The driving force from a rotation shaft 213a (see FIG. 4) of the driving source 213 is transmitted to the motor gear 234. The intermediate gear 233 meshes with the motor gear 234 and the upstream-side gear 232 to transmit the driving force from the motor gear 234 to the upstream-side gear 232. The intermediate gear 233 and the motor gear 234 are rotatably supported by a main body frame FL of the sheet containing device main body 210. The upstream-side gear 232 meshes with the intermediate gear 233 and the driving-side gear 231 to transmit the driving force from the intermediate gear 233 to the driving-side gear 231.

The driving-side gear 231 meshes with the upstream-side gear 232 and the driven-side gear 241 of the case side driving force transmission mechanism 240 to transmit the driving force from the upstream-side gear 232 to the driven-side gear 241 in a state where the sheet containing case 220 is inserted in the sheet containing device main body 210. The driven-side gear 241 is rotatably supported on the outer surface of the sheet containing case 220.

The case side driving force transmission mechanism 240 includes the driven-side gear train 240a including a plurality of container side gears. In this example, the driven-side gear train 240a includes the driven-side gear 241 and an arc-shaped reversal parallel axis gear (hereinafter, simply referred to as an arc-shaped gear) 242.

The driven-side gear 241 meshes with the driving-side gear 231 and the arc-shaped gear 242 in the main body side driving force transmission mechanism 230 in a state where the sheet containing case 220 is inserted into the sheet containing device main body 210, and transmits the driving force from the driving-side gear 231 to the arc-shaped gear 242. The arc-shaped gear 242 is fixed to the second pivot shaft 212 of the push-up member 222. The arc-shaped gear 242 transmits the driving force from the driven-side gear 241 to the second pivot shaft 212 of the push-up member 222. Accordingly, when the driving source 213 is rotationally driven in a state where the sheet containing case 220 is inserted into the sheet containing device main body 210, the push-up member 222 can be pivoted about the second pivot axis β2 via the driving-side gear 231 and the driven-side gear 241, and the distal end portion of the sheet placement section 221 can be moved upward about the first pivot axis β1. On the other hand, when the sheet containing case 220 is pulled out from the sheet containing device main body 210, meshing between the driving-side gear 231 and the driven-side gear 241 is released. Therefore, pushing-up to the sheet placement section 221 by the push-up member 222 is released and the tip end portion of the sheet placement section 221 moves downward.

In this example, in the sheet containing device 200, an upstream-side rotation axis α3 of the upstream-side gear 232 is located on the driven-side gear 241 side (S2 side in a pull-out direction) with respect to a first imaginary vertical line ε1 passing through a first rotation axis α1 of the driving-side gear 231.

Additionally, in the sheet containing device 200, when the sheet containing case 220 is inserted into the sheet containing device main body 210, a second rotation axis α2 of the driven-side gear 241 is located on S1 side in an insertion direction (the driving-side gear 231 side) with respect to a second imaginary vertical line ε2 passing through the upstream-side rotation axis α3 of the upstream-side gear 232.

### Sheet Feeding Device

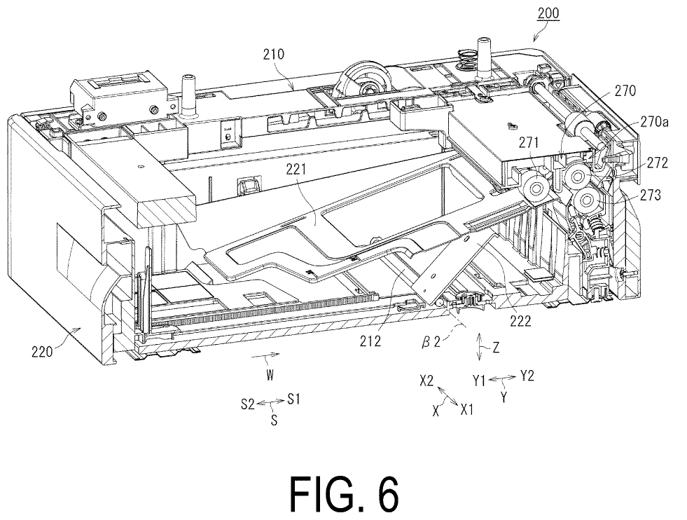

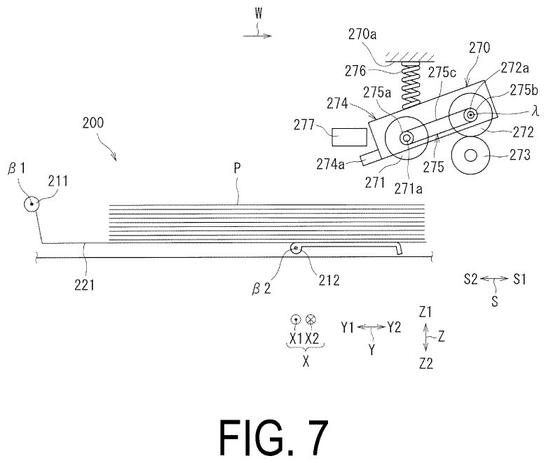

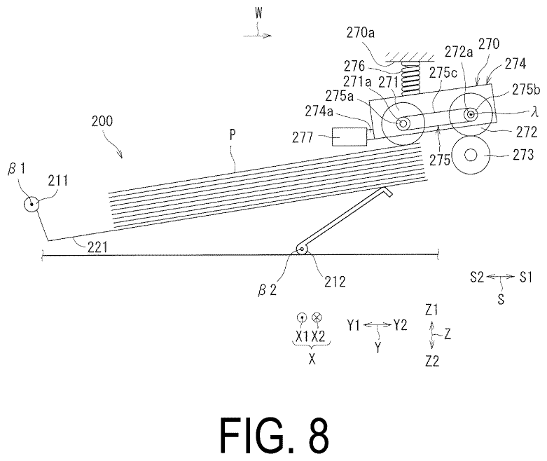

FIG. 6 is a perspective view including a vertical cross-section illustrating a state in which the sheet placement section 221 of the sheet containing device 200 is located at the upper limit position. FIGS. 7 and 8 are schematic diagrams schematically illustrating a state in which the sheet placement section 221 of the sheet containing device 200 is located at the lower limit position and a state in which the sheet placement section 221 of the sheet containing device 200 is located at the upper limit position, respectively.

The sheet containing device 200 further includes a sheet feeding device 270. The sheet feeding device 270 includes a pickup roller 271, a feed roller 272 (sheet feeding roller), a separation member (separation roller or separation pad (in this example, a separation roller 273)), a roller support member 274, and a feeding drive transmission mechanism 275.

The pickup roller 271 comes into contact with the upper surface of the sheet P placed on the sheet placement section 221 in the sheet containing device 200 and feeds the sheet P in the conveyance direction W. The pickup roller 271 rotates and draws the uppermost sheet P of the sheets P placed on the sheet placement section 221 in the sheet containing device 200 while pressing the uppermost sheet P. The pickup roller 271 feeds the uppermost sheet P placed (stacked) on the sheet placement section 221 one by one in the conveyance direction W. The feed roller 272 and the separation roller 273 separate and convey the sheets P, which are drawn by the pickup roller 271, one by one. The feed roller 272 conveys the sheet P, which is drawn by the pickup roller 271, one by one toward the sheet conveyance path 11 (see FIG. 1) in the conveyance direction W together with the separation roller 273. The separation roller 273 is disposed to face the feed roller 272. The separation roller 273 restricts conveyance in the conveyance direction W of the second and subsequent sheets P from the uppermost sheet P of the sheets P placed on the sheet placement section 221.

The roller support member 274 supports a rotation shaft 271a of the pickup roller 271 along the depth direction Y so that the rotation shaft 271a is rotatable about the rotation axis, and supports a rotation shaft 272a of the feed roller 272 along the depth direction Y so that the rotation shaft 272a is rotatable about the rotation axis. The roller support member 274 is provided on a sheet feeding device main body 270a so as to be pivotal about a pivot axis line λ (about the rotation shaft 272a) with respect to the rotation shaft 272a of the feed roller 272. Rotation driving force from a feeding drive unit (not illustrated) is transmitted via a conveyance drive transmission mechanism (not illustrated) to the feed roller 272. The feeding drive transmission mechanism 275 includes a gear train or timing pulleys and a timing belt (in this example, timing pulleys 275a, 275b and a timing belt 275c as illustrated in FIGS. 7 and 8). The feeding drive transmission mechanism 275 transmits the rotation driving force sent to the feed roller 272 to the pickup roller 271. The sheet feeding device 270 further includes a biasing member 276 (in this example, a coil spring). The roller support member 274 is biased by biasing force of the biasing member 276 so that the pickup roller 271 side moves downward Z2. In this example, the biasing member 276 is provided between the roller support member 274 and the sheet feeding device main body 270a.

The sheet feeding device 270 further includes an upper limit position detection unit 277 (an upper limit position sensor).

The upper limit position detection unit 277 detects the upper limit position (sheet feeding position) of the sheet placement section 221. Here, the upper limit position of the sheet placement section 221 is a position to which the uppermost sheet P on the sheet placement section 221 is fed (a position of a nip portion between the feed roller 272 and the separation roller 273). The roller support member 274 is provided with a detected portion (detected piece 274a). The upper limit position detection unit 277 detects upward Z1 or downward Z2 movement of the pickup roller 271 due to moving up and down of the sheet placement section 221, in this example, the presence or absence of the detected piece 274a due to moving up and down of the roller support member 274. Accordingly, the image forming apparatus 100 can recognize (detect) whether the sheet placement section 221 is located at the upper limit position.

### Present Embodiment

The main body side driving force transmission mechanism 230 includes the driving-side gear 231. The driving force is transmitted to the driving-side gear 231.

The case side driving force transmission mechanism 240 includes the driven-side gear 241. The driven-side gear 241 is configured to be able to mesh with the driving-side gear 231 when the sheet containing case 220 is inserted into the sheet containing device main body 210.

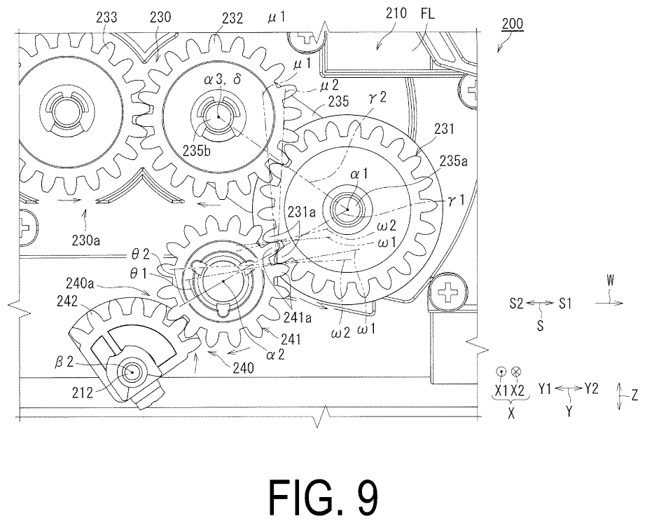

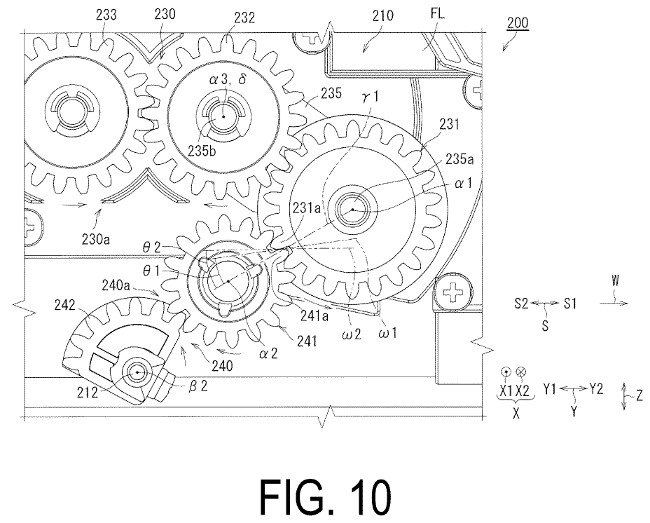

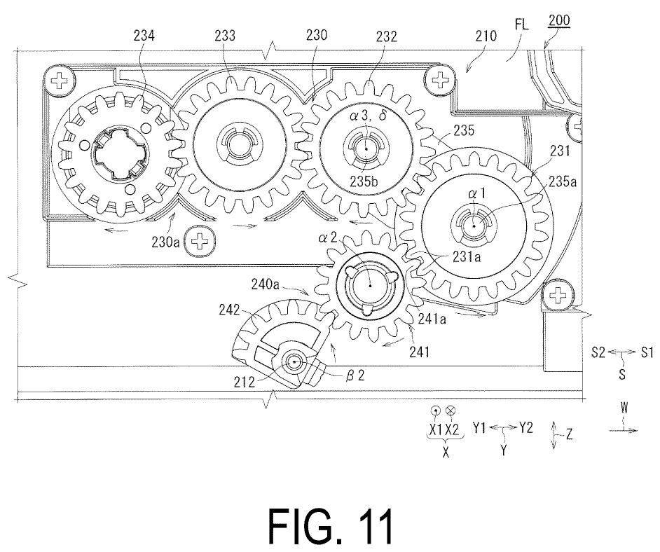

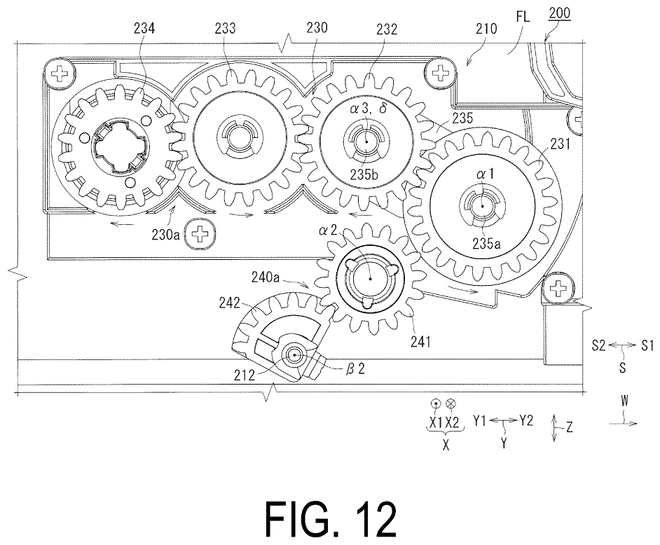

FIGS. 9 and 10 are each a front view illustrating a rotational process of the driving-side gear 231 and the driven-side gear 241. FIG. 11 is a front view illustrating a meshed state between driving-side gear tooth meshing portions 231a and driven-side gear tooth meshing portions 241a when the sheet placement section 221 reaches the upper limit position. FIG. 12 is a front view illustrating a state (gear slipped state) in which the driving-side gear tooth meshing portions 231a are disengaged from the driven-side gear tooth meshing portions 241a in a case where driving of the driving source 213 is not stopped even when the sheet placement section 221 is located at the upper limit position.

The sheet containing device 200 is configured such that the driving-side gear 231 can be separated from the driven-side gear 241 in a state where the sheet containing case 220 is inserted into the sheet containing device main body 210.

Incidentally, in the sheet containing device 200, when imaginary tangent lines ω1 and ω2 of contact surfaces of the driving-side gear tooth meshing portion 231a and the driven-side gear tooth meshing portion 241a at a position in which the driving-side gear 231 and the driven-side gear 241 are meshed with each other are parallel to a first imaginary straight line γ1 passing through the first rotation axis α1 of the driving-side gear 231 and the second rotation axis α2 of the driven-side gear 241, the following inconvenience occurs. Here, the “gear tooth meshing portions” refer to portions of gear teeth of the gears meshing in contact with each other.

In other words, the upper limit position (stop position) of the sheet placement section 221 is not detected due to a failure or the like of the upper limit position detection unit 277, and driving of the driving source 213 is not stopped even when the sheet placement section 221 is located at the upper limit position. In this case, when the imaginary tangent lines ω1 and ω2 are parallel to the first imaginary straight line γ1 even if the driving-side gear 231 can be separated from the driven-side gear 241, the driving-side gear tooth meshing portion 231a is less likely to disengage from the driven-side gear tooth meshing portion 241a. As a result, the driving-side gear 231 and/or the driven-side gear 241 is likely to be damaged.

In this regard, the sheet containing device 200 according to the present embodiment is configured as follows.

In the sheet containing device 200, as illustrated in FIGS. 9 and 10, the imaginary tangent lines ω1 and ω2 of the contact surfaces of the driving-side gear tooth meshing portion 231a and the driven-side gear tooth meshing portion 241a always intersect with the first imaginary straight line γ1 passing through the first rotation axis α1 and the second rotation axis α2 through the rotation of the driving-side gear 231.

In this configuration, the upper limit position of the sheet placement section 221 is not detected due to a failure or the like of the upper limit position detection unit 277, and driving of the driving source 213 is not stopped even when the sheet placement section 221 is located at the upper limit position. Even in such a case, the driving-side gear 231 can be separated from the driven-side gear 241, and the imaginary tangent lines ω1 and ω2 of the contact surfaces of the driving-side gear tooth meshing portion 231a and the driven-side gear tooth meshing portion 241a always intersect with the first imaginary straight line γ1 through the rotation of the driving-side gear 231 (see FIGS. 9 and 10). Therefore, the driving-side gear tooth meshing portion 231a can be easily disengaged from the driven-side gear tooth meshing portion 241a (the driving-side gear 231 can easily fall out of the driven-side gear 241) (see FIG. 12). As a result, the driving-side gear 231 and/or the driven-side gear 241 is less likely to be damaged.

Therefore, the driving-side gear 231 and/or the driven-side gear 241 can be effectively prevented from being damaged when the upper limit position of the sheet placement section 221 is not detected due to a failure or the like of the upper limit position detection unit 277.

### First Embodiment

In the present embodiment, in the sheet containing device 200, angles θ1 and θ2 (see FIGS. 9 and 10) respectively formed between the imaginary tangent line ω1 of the contact surface of the driving-side gear tooth meshing portion 231a and the first imaginary straight line γ1 and between the imaginary tangent line ω2 of the contact surface of the driven-side gear tooth meshing portion 241a and the first imaginary straight line γ1 are always 30 degrees or more and less than 45 degrees through the rotation of the driving-side gear 231.

In this configuration, driving of the driving source 213 is not stopped even when the sheet placement section 221 is located at the upper limit position, and even in such a case, the driving-side gear tooth meshing portion 231a can be more easily disengaged from the driven-side gear tooth meshing portion 241a (gear slippage can more easily occur). As a result, the driving-side gear 231 and/or the driven-side gear 241 is even less likely to be damaged.

### Second Embodiment

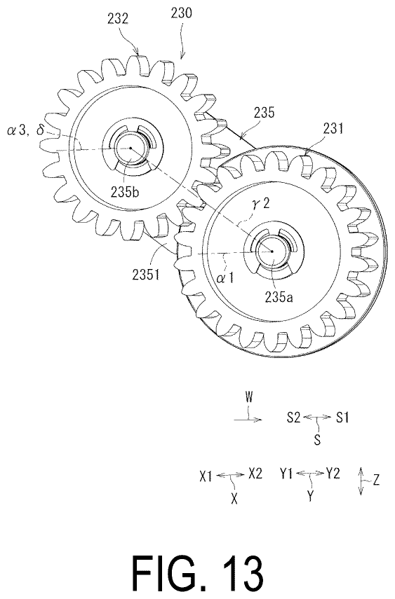

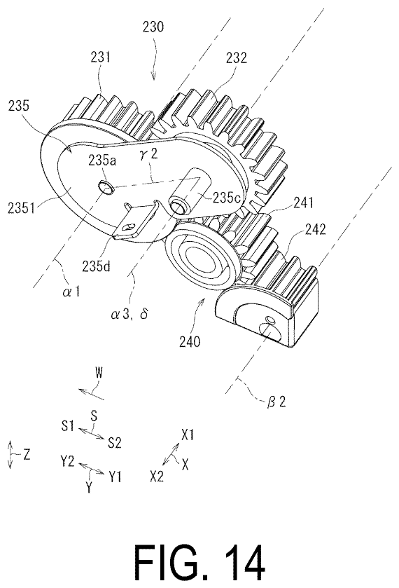

FIG. 13 is a perspective view of the driving-side gear 231, the upstream-side gear 232, and a support member 235 as viewed from the front side. FIG. 14 is a perspective view of the driving-side gear 231, the upstream-side gear 232, the support member 235, the driven-side gear 241, and the arc-shaped gear 242 as viewed from the rear side.

In the present embodiment, the main body side driving force transmission mechanism 230 further includes the upstream-side gear 232 and the support member 235 (a link plate). The upstream-side gear 232 meshes with the driving-side gear 231. In a state where the driving-side gear 231 and the upstream-side gear 232 are meshed with each other, the support member 235 supports the driving-side gear 231 and the upstream-side gear 232 such that the driving-side gear 231 and the upstream-side gear 232 are rotatable, and the support member 235 is swingable about a swing axis δ (with a swing shaft 235c (see FIG. 14) as a fulcrum) coaxial with the upstream-side rotation axis α3 of the upstream-side gear 232.

In this configuration, the support member 235 can easily and reliably swing the driving-side gear 231 about the swing axis δ with respect to the upstream-side gear 232 while maintaining the rotating motion of the driving-side gear 231 and the upstream-side gear 232. Thus, a configuration in which the driving-side gear 231 can be separated from the driven-side gear 241 in a state where the sheet containing case 220 is inserted into the sheet containing device main body 210 can be easily realized.

Specifically, the support member 235 includes a support member main body 2351, a first rotation shaft 235a, a second rotation shaft 235b, and the swing shaft 235c. The support member main body 2351 constitutes a plate-shaped swing arm portion extending along the direction of a second imaginary straight line γ2 passing through the first rotation axis α1 and the upstream-side rotation axis α3. The first rotation shaft 235a is disposed upright on the driving-side gear 231 side of the support member main body 2351. The driving-side gear 231 is disposed on the support member main body 2351 so as to be rotatable about the first rotation axis α1 (with the first rotation shaft 235a as a fulcrum). The second rotation shaft 235b is disposed upright on the upstream-side gear 232 side of the support member main body 2351. The upstream-side gear 232 is disposed on the support member main body 2351 so as to be rotatable about the upstream-side rotation axis α3 (with the second rotation shaft 235b as a fulcrum). The swing shaft 235c is disposed coaxially with the second rotation shaft 235b and upright on the opposite side of the upstream-side gear 232 of the support member main body 2351. The support member main body 2351 is supported by the main body frame FL of the sheet containing device main body 210 so as to be swingable about the swing axis δ (with the swing shaft 235c as a fulcrum).

### Third Embodiment

In the present embodiment, the contact surface of the driving-side gear tooth meshing portion 231a and/or the contact surface of the driven-side gear tooth meshing portion 241a is formed in a curved surface shape such that

the angles θ1 and θ2 respectively formed between the imaginary tangent line ω1 of the contact surface of the driving-side gear tooth meshing portion 231a and the first imaginary straight line γ1 and between the imaginary tangent line ω2 of the contact surface of the driven-side gear tooth meshing portion 241a and the first imaginary straight line γ1 increase, through the rotation of the driving-side gear 231, during a period from when the driving-side gear tooth meshing portion 231a and the driven-side gear tooth meshing portion 241a come into contact with each other to when the driving-side gear tooth meshing portion 231a and the driven-side gear tooth meshing portion 241a are separated from each other.

In this configuration, driving of the driving source 213 is not stopped even when the sheet placement section 221 is located at the upper limit position, and even in such a case, the driving-side gear tooth meshing portion 231a can be more easily disengaged from the driven-side gear tooth meshing portion 241a (gear slippage can more easily occur). As a result, the driving-side gear 231 and/or the driven-side gear 241 is even less likely to be damaged.

### Fourth Embodiment

In the present embodiment, the driving-side gear 231 is biased by a component of force in a direction in which the driving-side gear 231 comes into contact with the driven-side gear 241 due to the self-weight of the driving-side gear 231 or a biasing member (in this example, the self-weight).

In this configuration, the driving-side gear tooth meshing portion 231a and the driven-side gear tooth meshing portion 241a can be easily meshed with each other while maintaining the easiness of disengagement (easiness of gear slippage) of the driving-side gear tooth meshing portion 231a from the driven-side gear tooth meshing portion 241a.

### Fifth Embodiment

In the present embodiment, in a state where the rotation of the driven-side gear 241 is restricted, the driving-side gear 231 swings about the swing axis δ so as to increase the angles respectively formed between the imaginary tangent line ω1 and the first imaginary straight line γ1 and between the imaginary tangent line ω2 and the first imaginary straight line γ1.

In this configuration, driving of the driving source 213 is not stopped even when the sheet placement section 221 is located at the upper limit position, and even in such a case, the driving-side gear tooth meshing portion 231a can be easily disengaged from the driven-side gear tooth meshing portion 241a (gear slippage can easily occur). As a result, the driving-side gear 231 and/or the driven-side gear 241 is even less likely to be damaged.

### Sixth Embodiment

Incidentally, in the sheet containing device 200, in a configuration in which imaginary normal lines μ1 and μ2 (see FIG. 9) orthogonal to the imaginary tangent lines ω1 and ω2 are parallel to the second imaginary straight line γ2 (see FIG. 9) passing through the first rotation axis α1 of the driving-side gear 231 and the upstream-side rotation axis α3 of the upstream-side gear 232, driving of the driving source 213 is not stopped even when the sheet placement section 221 is located at the upper limit position. In such a case, the driving-side gear tooth meshing portion 231a is less likely to disengage from the driven-side gear tooth meshing portion 241a. Therefore, the driving-side gear 231 and/or the driven-side gear 241 is likely to be damaged.

In this regard, in the sheet containing device 200 of the present embodiment, the imaginary normal lines μ1 and μ2 orthogonal to the imaginary tangent lines ω1 and ω2 intersect with the second imaginary straight line γ2 passing through the first rotation axis α1 of the driving-side gear 231 and the upstream-side rotation axis α3 of the upstream-side gear 232.

Accordingly, even in a case where driving of the driving source 213 is not stopped even when the sheet placement section 221 is located at the upper limit position, the driving-side gear tooth meshing portion 231a can be easily disengaged from the driven-side gear tooth meshing portion 241a (gear slippage can easily occur). As a result, the driving-side gear 231 and/or the driven-side gear 241 is less likely to be damaged.

### OTHER EMBODIMENTS

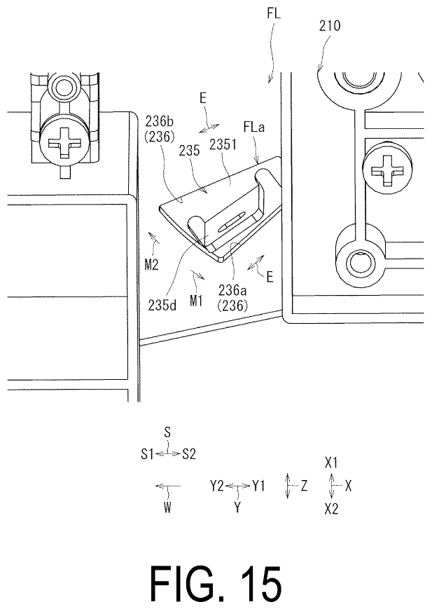

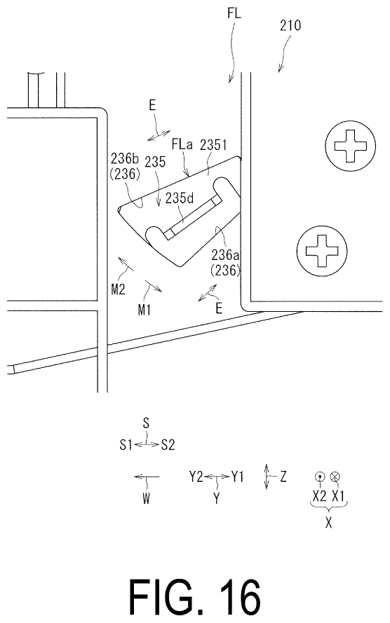

FIGS. 15 and 16 are a perspective view and a rear view, respectively, of an example (236a) of a restricting portion 236 that restricts swinging of the support member 235, as viewed from the rear side.

Incidentally, the driving-side gear 231 may excessively slip with respect to the driven-side gear 241.

In this regard, the sheet containing device 200 includes the restricting portion 236 (see FIGS. 15 and 16).

The restricting portion 236 restricts swinging of the support member 235 about the swing axis δ toward the S1 side in the insertion direction due to gear slippage of the driving-side gear 231 with respect to the driven-side gear 241.

As just described, swinging of the support member 235 about the swing axis δ toward the S1 side in the insertion direction when the driving-side gear 231 slips against the driven-side gear 241, and thus the driving-side gear 231 can be effectively prevented from excessively slipping against the driven-side gear 241.

Specifically, the support member main body 2351 is provided with a restricted portion 235d (see FIGS. 14, 15, and 16). The restricted portion 235d protrudes from the support member main body 2351 to the opposite side of the driving-side gear 231 and the upstream-side gear 232. The main body frame FL of the sheet containing device main body 210 is provided with a through hole FLa (FIGS. 15 and 16) through which the restricted portion 235d passes. The restricting portion 236 includes a part of the through hole FLa. Specifically, the through hole FLa provided in the main body frame FL includes a pair of edge portions (236a, 236b) along a radial direction E about the swing axis δ. The restricting portion 236 includes the pair of edge portions (236a, 236b). One edge portion 236a is located below the restricted portion 235d, and comes into contact with the restricted portion 235d by swinging of the support member 235 in a first swing direction M1. The other edge portion 236b is located above the restricted portion 235d, and comes into contact with the restricted portion 235d by swinging of the support member 235 in a second swing direction M2 opposite to the first swing direction M1. At this time, the driving-side gear tooth meshing portion 231a is disengaged from the driven-side gear tooth meshing portion 241a (the driving-side gear 231 slips against the driven-side gear 241). In this example, the restricted portion 235d is formed by punching the support member main body 2351 by die-cutting and then folding back to the opposite side to the driving-side gear 231 and the upstream-side gear 232 by bending.

The disclosure is not limited to the embodiments described above and can be embodied in other specific forms. The present embodiments are therefore to be considered in all respects as illustrative and not restrictive. The scope of the disclosure is indicated by the claims rather than by the foregoing description. In addition, all changes which come within the meaning and range of equivalency of the claims are therefore intended to be embraced therein.

1. A sheet containing device, comprising:

2. The sheet containing device according to claim 1, wherein
of the contact surface of the driving-side gear tooth meshing portion and the first imaginary straight line and between the imaginary tangent line of the contact surface of the driven-side gear tooth meshing portion and the first imaginary straight line are always 30 degrees or more and less than 45 degrees through the rotation of the driving-side reversal parallel axis gear.

3. The sheet containing device according to claim 1, wherein

4. The sheet containing device according to claim 1, wherein

5. The sheet containing device according to claim 1, wherein

6. The sheet containing device according to claim 3, wherein

7. The sheet containing device according to claim 3, wherein

8. An image forming apparatus, comprising:
the sheet containing device according to claim 1.
